(19) United States
(12) Patent Application Publication
(10) Pub. No.: US 2019/0266501 A1
(43) Pub. Date: Aug. 29, 2019

(54) SYSTEM AND METHOD FOR PREDICTING MINERALOGICAL, TEXTURAL, PETROPHYSICAL AND ELASTIC PROPERTIES AT LOCATIONS WITHOUT ROCK SAMPLES

(71) Applicant: CGG SERVICES SAS, Massy Cedex (FR)

(72) Inventor: Julio TAVARES, Houston, TX (US)

(21) Appl. No.: 16/149,324

(22) Filed: Oct. 2, 2018

Related U.S. Application Data
(60) Provisional application No. 62/635,801, filed on Feb. 27, 2018.

(51) Int. Cl. G06N 5/04; G06N 99/00; G01V 99/00

(52) U.S. Cl. CPC G06N 5/04; G01V 99/005; G06N 99/005

(57) ABSTRACT

A method for predicting mineralogical, textural, petrophysical and/or elastic properties at locations without rock samples based on well log data is provided. The method includes obtaining well log data and values of a target property measured by analyzing rock samples at rock sample locations. The method further includes building and calibrating a prediction model using machine learning algorithms, the well log data and the values of the target property at the rock sample locations. The method then estimates values of the target property at one or more locations without rock samples using the prediction model.

### BACKGROUND

### Technical Field

Embodiments of the subject matter disclosed herein generally relate to methods and systems related to investigating a geological structure along a well drilled for exploration or exploitation of resources, and, more particularly, to using machine learning techniques to expand information obtained from rock sample analysis and well logs.

### Discussion of the Background

When a well is drilled for exploring the presence of sought-after resources (such as oil and gas or other minerals), rock samples such as core plugs and cuttings are acquired and analyzed to determine the physical and chemical nature of the geological formation along the well. The rock sample analysis yields information such as mineralogy, texture, petrophysical properties, elastic properties, fluid content, geologic age, and potential oil and gas productivity of reservoir rocks at the location from which a sample is acquired. Various methods and tools for rock sample analysis enable hydrocarbon reservoir characterization, drilling optimization and production management.

As illustrated in FIG. 1A, cuttings are sand-like particles produced by a rotary bit as a hole is drilled into the earth. Rock cores illustrated in FIG. 1B are small portions of a rock formation extracted from an existing well. Each of these samples is associated with a location (e.g., depth or range of depths) along the well.

The cost of sample analysis depends, mainly, on the number of samples to be analyzed per well. For cost reduction purposes, the analysis is limited to key wells within an oil and gas field. The key wells are selected so as to build a reference framework to enable predicting the performance of additional wells in the same field. In addition, cost is reduced by decreasing the number of rock samples along each analyzed well. The sampling interval along a well may vary for various operational reasons and may result in a lack of samples in areas of interest, e.g., layers with hydrocarbon content.

Therefore, it is desirable to develop techniques for generating information such as that produced by rock analysis at locations without rock samples.

### SUMMARY

Machine learning techniques are used in various embodiments to predict the rock properties (e.g., mineralogical, textural, petrophysical and elastic) at locations without rock samples. These predictions are based on data-driven prediction models generated and calibrated using well logs and existing rock analysis output. Enhanced knowledge about values of multiple properties improves hydrocarbon reservoir characterization, drilling optimization or resource extraction.

According to an embodiment, there is a method for predicting values of at least one mineralogical, textural, petrophysical and/or elastic property at locations without rock samples. The method includes obtaining well log data and values of a target property from analyzing rock samples at rock sample locations. The method further includes building and calibrating a prediction model using machine learning algorithms, the well log data and the values of the target property at the rock sample locations, and the, estimating values of the target property at one or more locations without rock samples using the prediction model.

According to an embodiment, there is a geophysical investigation device configured to predict values of at least one mineralogical, textural, petrophysical, and/or elastic property at locations without rock samples. The device includes an interface configured to obtain well log data and values of a target property from analyzing rock samples at rock sample locations. The device also includes a processor configured to build and calibrate a prediction model using machine learning algorithms, the well log data and the values of the target property at the rock sample locations, and to estimate values of the target property at one or more locations without rock samples using the prediction model.

According to yet another embodiment there is a non-transitory computer readable medium storing executable instructions which, when executed by a processor, implement a method for predicting mineralogical, textural, petrophysical and/or elastic properties at locations without rock samples. The method includes obtaining well log data and values of a target property acquired from analyzing rock samples at rock sample locations, building and calibrating a prediction model using machine learning algorithms, the well log data and the values of the target property at the rock sample locations, and estimating values of the target property at one or more locations without rock samples using the prediction model.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A and 1B illustrate rock samples;

FIG. 2 is a schematic illustration of the inventive concept;

FIG. 3 is a schematic representation of data acquired along a well;

FIG. 4 is a schematic diagram illustrating the inventive concept;

FIG. 5 is an illustration of a RoqSCAN™ apparatus;

FIG. 6 illustrates the pore aspect ratio quantity;

FIG. 7 is a flowchart of a method according to an embodiment;

FIGS. 8A and 8B are illustrations of quantities that may be target property output by a method according to an embodiment;

FIG. 9 is a graph illustrating a measured and estimated values;

FIG. 10 is a graph illustrating correlation of measured and estimated pore ratio values;

FIG. 11 is a graph that illustrates p-wave velocity prediction accuracy;

FIG. 12 is a graph that illustrates s-wave velocity prediction accuracy;

FIG. 13 illustrates density prediction accuracy; and

FIG. 14 is a geophysical investigation device according to an embodiment.

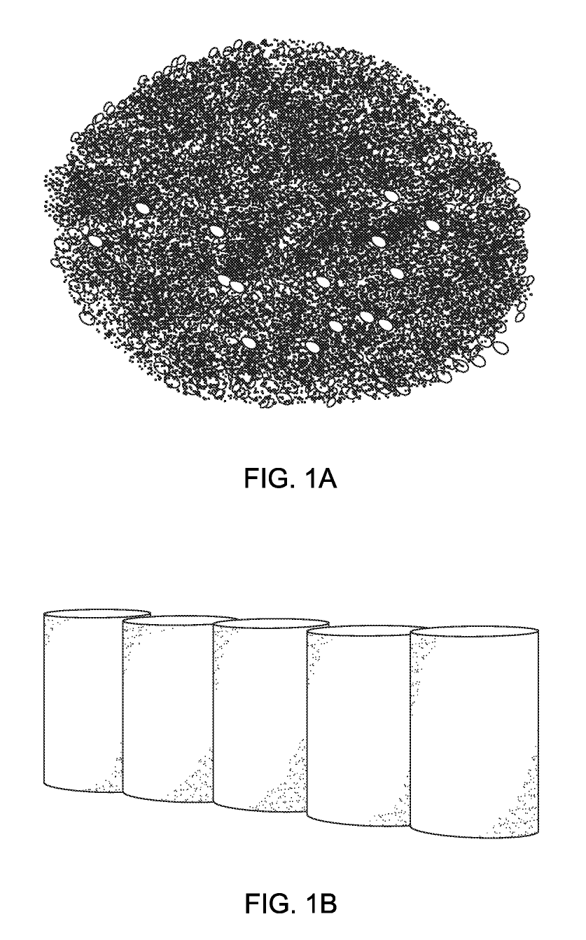

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed using terminology of geologic exploration of oil and gas-bearing fields.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a method for estimating mineralogical, textural, petrophysical or elastic properties, with laboratory level of details, at locations without rock samples. A target property in the following description is a mineralogical, textural, petrophysical or elastic property whose value may be obtained by rock sample analysis with laboratory level of details, but not measured with logging tools along the well (i.e., not in the well log data). For example, the target property may be a mineralogical property such as mineral volumes of Quartz, K-feldspar, Plagioclase Feldspar, Illite/Muscovite, Mixed Clay, Mixed clay calcareous, Kaolinite, Biotite/Phlogopite, Chlorite, Glauconite, Calcite, Dolomite, Ankerite, Anhydrite/Gypsum, Halite, Fluorite, Barite, Siderite, Pyrite, Heavy Minerals, etc. In another example, the target property may be a petrophysical properties such as Average Void Aspect Ratio or Porosity. In yet another example, the target property may be a textural property such as Void size distribution or Void Aspect Ratio Distribution in Relative Void Area Percent. Yet again, target property may be an elastic property such as P-wave velocity, S-wave velocity or Density. These examples are illustrative and not an exhaustive list of possible target property.

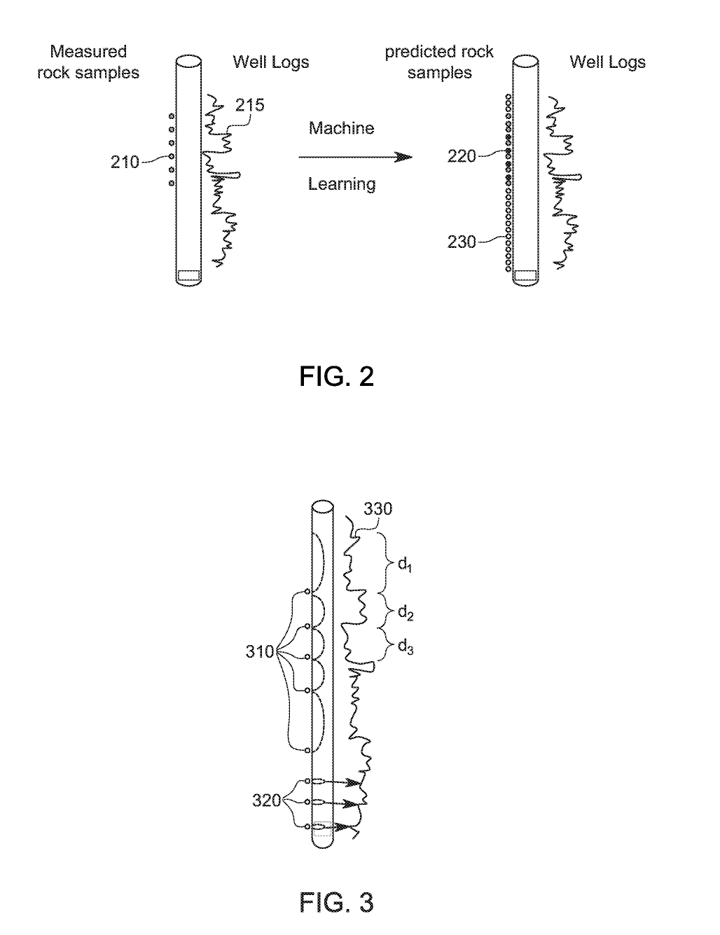

The method includes receiving values 210 of a target property at locations with rock samples in a well, and a well log 215 including values of one or more features (a single one is illustrated) measured along the well, as illustrated on the left side of FIG. 2.

Machine learning is then used to generate a prediction model. With this prediction model, the values of one or more features (such as, density, resistivity, porosity, mineral volume, etc.) measured along the well are used to predict the values 220 of the target property at locations without rock samples, yielding a finer granularity (higher resolution) of target property values in between the locations of the analyzed rock samples and extending the range of locations with target values 230 as illustrated on the right side of FIG. 2.

In mathematical terms, values T(sᵢ) of a target property T are obtained at locations sᵢ based on rock sample analysis. A prediction model P is “trained” so as T(sᵢ)=P(Lⱼ(sᵢ)) with j≥1, where Lⱼ(sᵢ) indicates values of one or more log-measured features at locations sᵢ. Identifying log measurements Lⱼ at locations sᵢ is a process known as “upscaling.” The prediction model P is then applied for locations xₖ with log measurements but without rock samples to estimate the values T(xₖ) of the target property at these locations: T(xₖ)=P(Lⱼ(xₖ)).

In other words, a machine learning technique is used to build a data-driven prediction model that estimates one or more rock properties which are measurable when rock samples (core plugs or cuttings) are available. Well log data and values of the targeted property obtained from rock analysis are used to calibrate the prediction model. Building the prediction model may include an upscaling process to single out values of the one or more properties in the well log, which values correspond to the locations where values of the target rock property are known from rock sample analysis. The prediction models then enable estimating rock properties at locations without rock samples. Alternatively or additionally, the prediction model may calibrated based on rock analysis of samples from one well may be used to predict values of the target property in another well on the same oil and gas field.

As illustrated in FIG. 3, rock samples (cuttings 310 or core plugs 320) may be collected along the well at regular or variable intervals between 10 and 50 ft, but gaps larger than 50 ft may occur due to well drilling-related limitations. The rock samples are investigated (for example, using a portable rock analysis lab such as RoqSCAN™), and a log (i.e., a series of pairs of property values and location/depths) with coarse sampling intervals (d₁, d₂, d₃, etc.) is generated for each mineralogical, textural, petrophysical and elastic property that has been obtained from the rock analysis.

On the other hand, well log 330 include a series of much more frequent measurements, for example, at 0.5 ft along the well. Logging tools performing these measurements may be a string of one or more instruments and sensors that are lowered into the well (e.g., may be part of the drill). Logging tools may measure the natural gamma ray, electrical, acoustic, stimulated radioactive responses, electromagnetic, nuclear magnetic resonance, pressure and other properties of the rocks and the fluids they contain. Other measurement sensor and devices may be used independently. The well logs may include values obtained by scanning one or more of density, porosity, resistivity, gamma-ray response, etc., along the well.

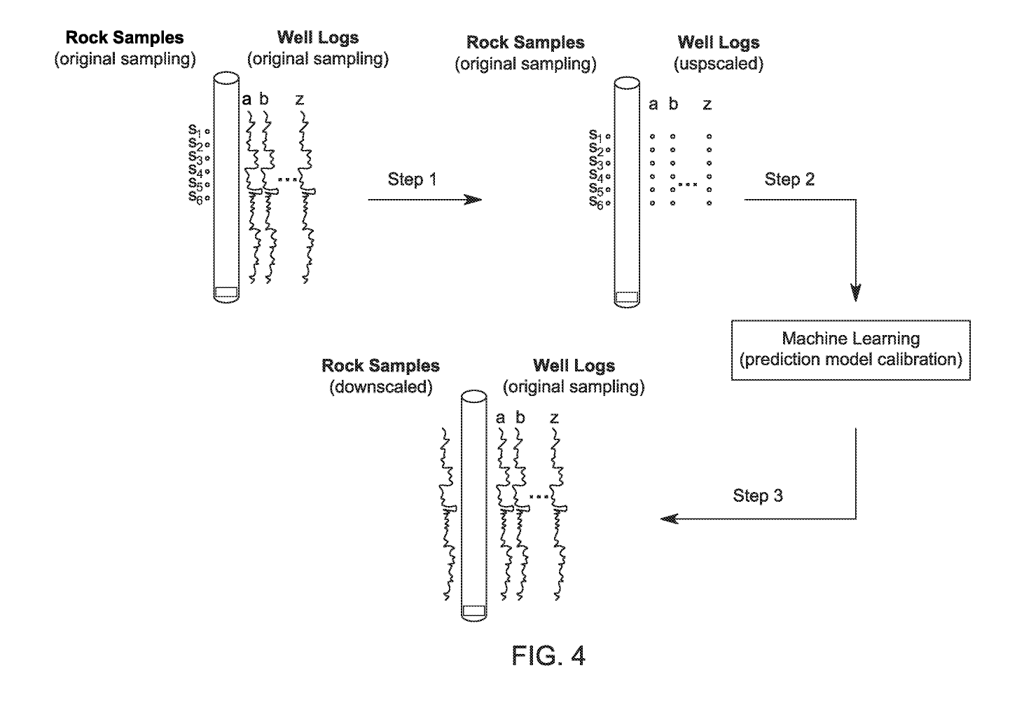

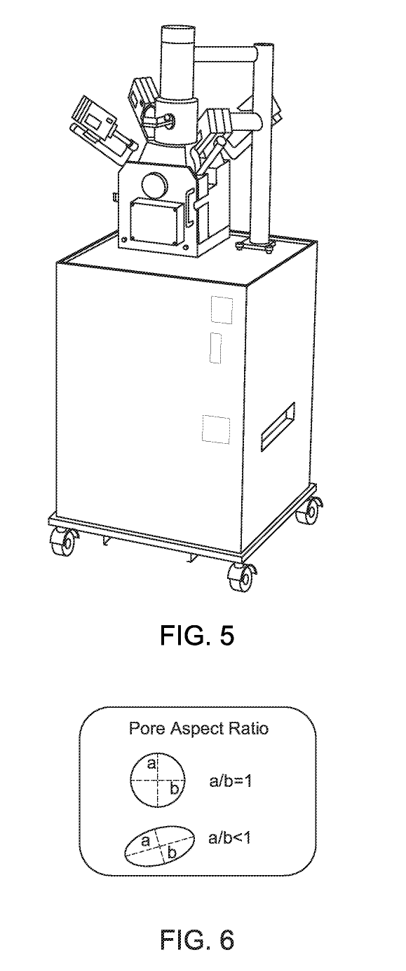

FIG. 4 illustrates building, calibrating and applying the prediction model. Values of the target property have been obtained at the rock sample locations (s₁, s₂, s₃, s₄, s₅, s₆) by performing rock analysis of rock samples. Rock sample properties may be any one of compositional, mineralogical, textural, and/or rock fabric data. A RoqSCAN™ (illustrated in FIG. 5) apparatus is a suitable commercially available rock sample measurement system usable in a laboratory and/or at a wellhead to analyse rock samples. Well logs may include gamma ray, resistivity, density, neutron porosity and compressional sonic data. Which and how many features are logged may vary from site to site, from a drilling company to another. The relevance of different properties changes depending on the target property. Although as a first impression there is safety in number, i.e., the more data points and features, the more accurate the predictions, one should balance the availability and desire to include as much information as possible with the risk of perturbing the predicted values due to local peculiarities.

First, the well logs are upscaled to the rock samples' positions. That is, values of one or more properties (a, b, . . . , z) recorded in the well log are provided for rock sample locations (s₁, s₂, s₃, s₄, s₅, s₆). Looking back to FIG. 3, log values are extracted for the depths d₁, d₁+d₂+d₃, etc.

When cuttings are available, the rock sample to be analyzed at a laboratory and/or at a wellhead is composed of a mix of samples obtained over a specific depth interval along the well. Therefore, a statistical measurement (mean or median or mode, etc.) may be used to upscale the well logs on these intervals. If the rock sample is a core plug, the upscaling process is done by directly selecting the well log value(s) at the location (depth) where the rock sample was collected.

For example, U.S. Pat. No. 9,613,253 (the entire content of which is incorporated herein by reference) discloses a method and system for obtaining pore-space textural data. Textural data may include pore aspect ratio, which is illustrated in FIG. 6. The elastic response of the rock depends on the pore shape characterized by the pore aspect ratio. This property provides insight on the stress regime for the interval of interest and enables locating the stiffest or softest intervals that are more favorable for hydraulic fracturing in unconventional reservoirs. In another example, U.S. Pat. No. 10,025,971 describes a method for obtaining rock fabric data such as a fracability index.

Returning now to FIG. 4, in a second step, the prediction model is built using the upscaled well log values and the values obtained from rock analysis as a training-set in the machine learning process. The more log features are taken into consideration, the better the predictions obtained with the resulting prediction model. The rock physics model may be extended to include petrophysical or elastic properties. For example, U.S. Patent Application Publication No. 2017/0023689 (the entire content of which is incorporated herein by reference) discloses a rock physics model for predicting petrophysical or elastic properties (e.g., p-wave velocity, s-wave velocity and/or density).

Conventional machine learning algorithms may be used to build and calibrate the prediction model. Suitable machine learning algorithms include supervised learning methods and unsupervised learning methods. Suitable unsupervised methods include gradient boost regression (also known as gradient tree boosting), random forest regression, single and multiple linear (and non-linear) regressions, neural networks, support vector machines and Bayesian methods. Conventional machine learning algorithms are readily available. For example, scikit-learn.org provides open-source machine learning algorithms.

The third step illustrated in FIG. 4 is using the model to predict values of the target property at all the locations with the well log values (i.e., a finer sampling interval). and/or predicting values for another well using the prediction model and the well logs of the other well. The calibrated prediction model may be applied on the original log sampling rate of the well logs to predict targeted rock properties for every well measurement location. This process produces a downscaled (finer sampling interval) the target property profile (pseudo-log) along the well.

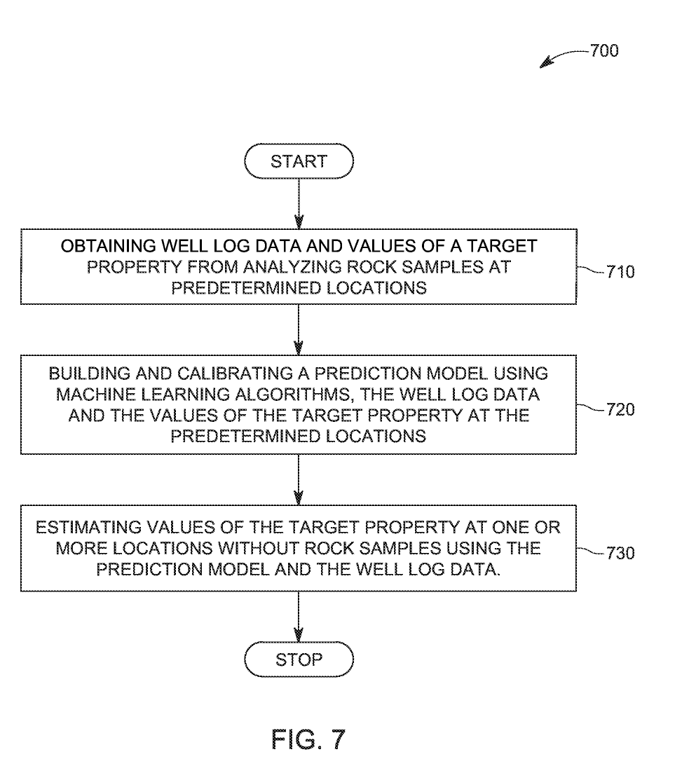

FIG. 7 is a flowchart of a method 700 for predicting mineralogical, textural, petrophysical and elastic properties at locations without rock samples according to an embodiment. Method 700 includes obtaining well log data and values of a target property from analyzing rock samples at rock sample locations at 710. The well log data may include values of gamma ray, resistivity, density, neutron porosity and compressional sonic data, which may be measured 10-100 times more often with depth than intervals between the rock sample locations. Analyzing the rock samples may include one or more of automated mineralogy, quantitative pore analysis, grain size and shape analysis, rock typing, quantitative lithotyping, rheology, high-resolution backscattering electron and secondary electron imaging, scanning electron microscopy and energy dispersive spectroscopy.

Method 700 further includes building and calibrating a prediction model using machine learning algorithms, the well log data and the values of the target property at the rock sample locations at 720. This step may include upscaling values in the well log data so as to correspond to the rock sample locations. The machine learning algorithms may include any one of gradient boost regression, random forest regression, single and multiple linear and non-linear regressions, neural networks, support vector machines and Bayesian methods.

Finally, at 730, values of the target property are estimated at one or more locations without rock samples using the prediction model. Having target property values at more locations along a well enables making better decisions related to drilling optimization or resource extraction. For example, the mineralogical, textural, petrophysical and elastic properties enable selecting such locations along the well where to inject pressurized fluids such as to increase the volume of extracted hydrocarbon.

The one or more locations without rock samples at which the values of the target property are estimated using the prediction model may be in a well other than the well in which the well log data was acquired, the prediction model being in this case applied using other well log data acquired in the other well.

The present inventive concept has been tested for two datasets. A gradient boost regression has been used in these tests. However, a random forest regression is also giving good results. RoqSCAN™ laboratory analysis of rock samples was used to obtain values of the pore aspect ratio for 140 rock samples acquired along the well at an average sampling interval of 30 ft.

The well data included 31 features listed in the following Table 1. All logs were upscaled to determine these feature values corresponding to the rock sample locations to create the training-set to build the prediction model. The prediction model has been applied to the well log data for the original sampling interval of 0.5 ft so as to predict the pore aspect ratio with this finer sampling interval.

TABLE 1

| | Acronym | Description |
|---|---|---|
| 1 | VPMOD | P-wave |
| 2 | VSMOD | S-wave |
| 3 | DENMODEL | Density |
| 4 | SW | Water Saturation |
| 5 | PHIE | Effective Porosity |
| 6 | PHIT | Total Porosity |
| 7 | GR | Gamma Ray |
| 8 | RT | Resistivity |
| 9 | TOC_LOG | Total Organic Content |
| 10 | VCAL | Calcite volume |
| 11 | VCLAY | Clay volume |
| 12 | VFELDZ | Feldspar volume |
| 13 | VKERO | Kerogen volume |
| 14 | VPYRITE | Pyrite volume |
| 15 | VSS | Quartz volume |
| 16 | PP | Pore Pressure |
| 17 | FP | Fracture Pressure |
| 18 | BNBT_TEC_STRESS_SXX | Total stress in X direction |
| | | (minimum horizontal stress) |
| 19 | BNBT_TEC_STRESS_SYY | Total stress in Y direction |
| | | (maximum horizontal stress) |
| 20 | BNBT_DEL_N | Normal Weakness |
| 21 | BNBT_DEL_T | Tangential weakness |
| 22 | BNBT_EPSILON | Thomsen Epsilon |
| 23 | BNBT_DELTA | Thomsen Delta |
| 24 | BNBT_GAMMA | Thomsen Gamma |
| 25 | BNBT_VP_FAST_VERT | Compression fast velocity |
| 26 | BNBT_VS_FAST | Shear fast velocity |
| 27 | BNBT_VS_SLOW | Shear slow velocity |
| 28 | BNBT_E_XX | Young's Modulus in X |
| | | direction (minimum |
| | | horizontal stress direction) |
| 29 | BNBT_E_YY | Young's Modulus in Y |
| | | direction (maximum |
| | | horizontal stress direction) |
| 30 | BNBT_PR_XX | Poisson's Ratio in X |
| | | direction (minimum |
| | | horizontal stress direction) |
| 31 | BNBT_PR_YY | Poisson's Ratio in Y |
| | | direction (maximum |
| | | horizontal stress direction) |

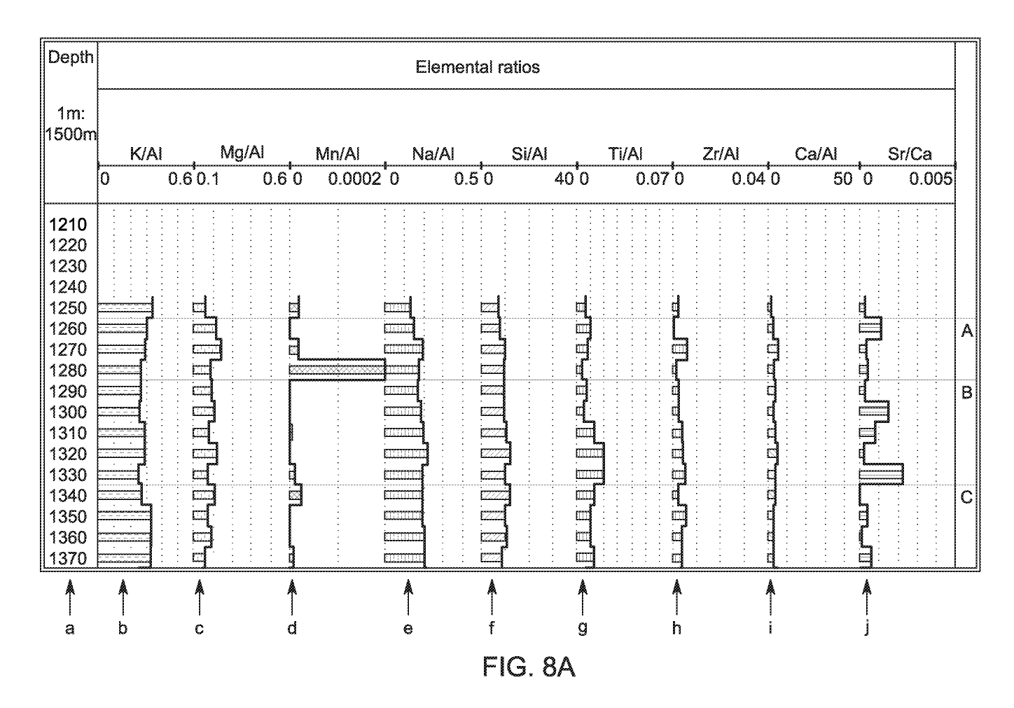

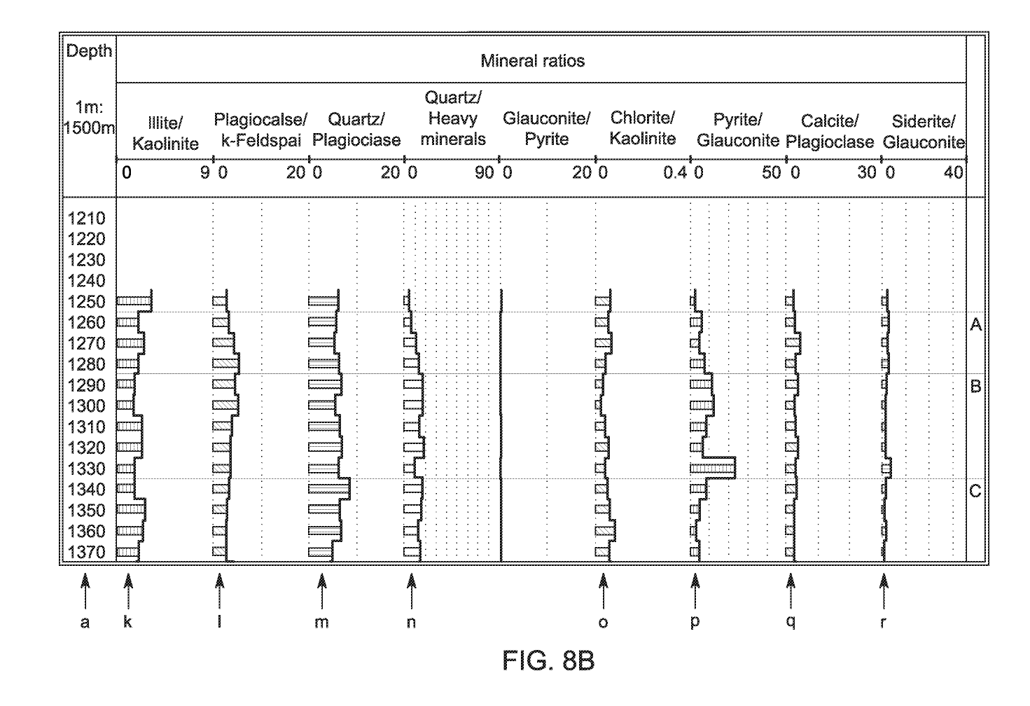

FIGS. 8A and 8B illustrate elemental ratios and mineral ratios that may be the target property output by a method according to an embodiment. The horizontal bar graphs indicate values at a 30 ft sampling interval and the lines there-between are predictions at 0.5 ft sampling interval. In this figure “a” indicates depth, b-j in FIG. 8A are elemental ratios (i.e., “b” is K/Al, “c” is Mg/Al, “d” is Mn/Al, “e” is Na/Al, “f” is Si/Al, “g” is Ti/Al, “h” is Zr/Al, “i” is Ca/Al, “j” is Sr/Ca), and k-r indicate mineral ratios (i.e., “I” is illite/Kaolinite, “m” is Plagioclase/K-Feldspar, “n” is Quartz/Plagioclase, “o” is Quartz/Heavy minerals, “p” is Glauconite/Pyrite, “q” is Chlorite/Kaolinite, “r” is Pyrite/Glauconite, “s” is Calcite/Plagioclase, and “t” is Siderite/Glauconite). Note that the quartz/heavy mineral ratio is essentially 0 and therefore its graph is associated with a label. The labels “A”, “B” and “C” of the right side indicate different rock layers.

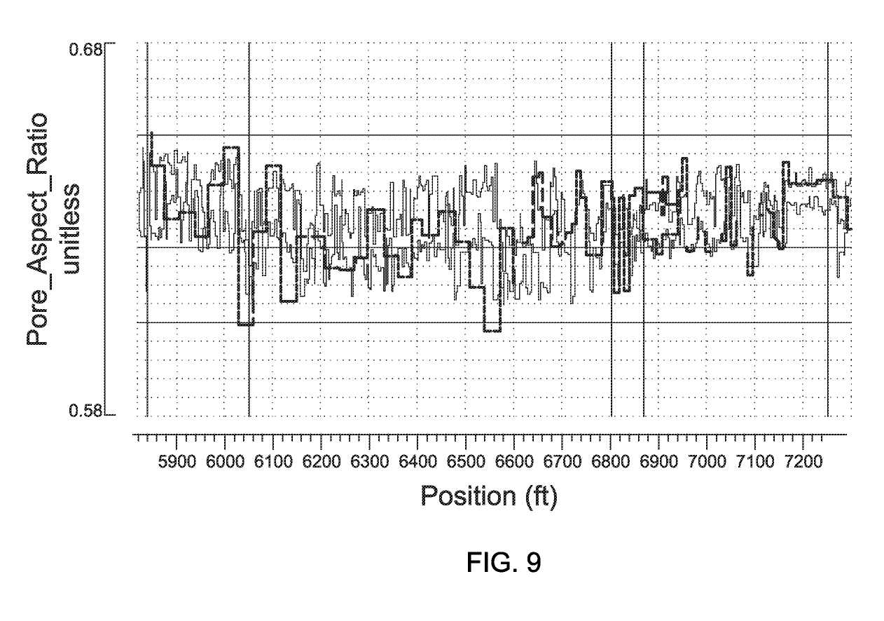

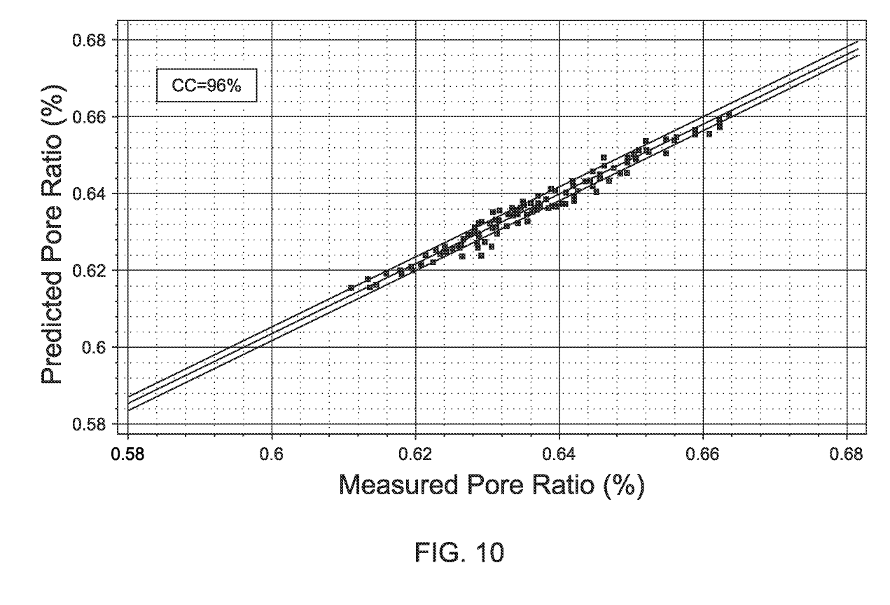

FIG. 9 illustrates the measured pore ratio (dashed line corresponding to a 30 ft sampling interval) and the predicted pore aspect (corresponding to a 0.5 ft sampling interval). FIG. 10 shows correlation (CC) between measured and predicted pore aspect ratio.

The second test of the inventive concept was performed using well log data from two horizontal wells, only one well having also rock samples. Eight logged features were used: two were directly measured values and six were derived from the directly measured values. The directly measured were Gamma Ray (GR) and Rate of Penetration (ROP). The derived features are: squared GR (GRsq), cubed GR (GRcu), square root of GR (GRsqrt), squared ROP (ROPsq), cubed ROP (ROPcu), square root of ROP (ROPsqrt).

The auxiliary well has both well log data and rock samples used to build and calibrate the prediction model, while the target well has well log data only. The rock samples from the auxiliary well were analyzed at a laboratory, and elastic properties, such as p-wave velocity, s-wave velocity and density, were estimated at each rock sample using a rock physics modeling approach. In this case, the available well log data (upscaled to the rock samples' sampling rate) were used to build a prediction model for each elastic property independently.

The calibrated prediction model was used on the auxiliary well to verify the accuracy of the prediction. However, the same prediction models were applied on the target well to predict the elastic property along its trajectory. The predictions were applied at different sampling intervals: original well log sampling interval, using upscaled logs at 10 ft sampling interval and 30 ft sampling interval, and at rock sampling interval.

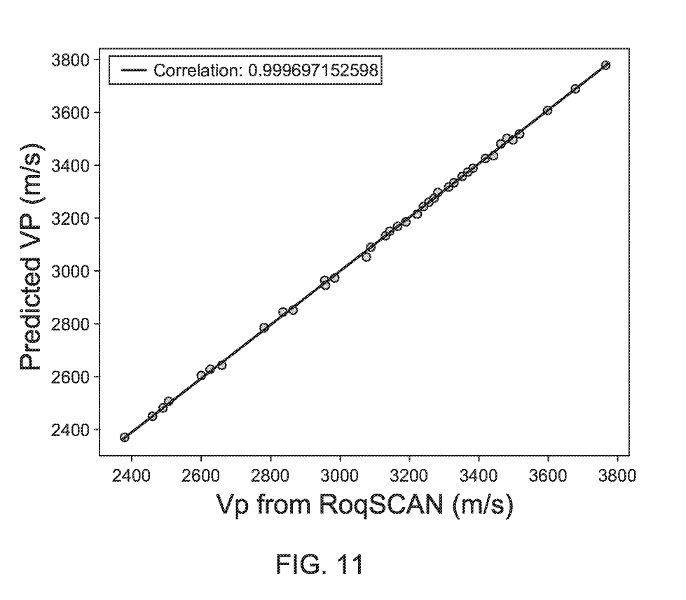

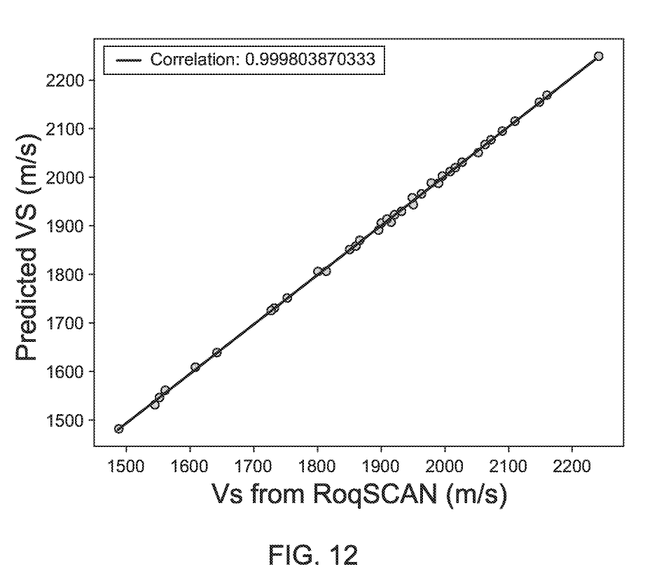

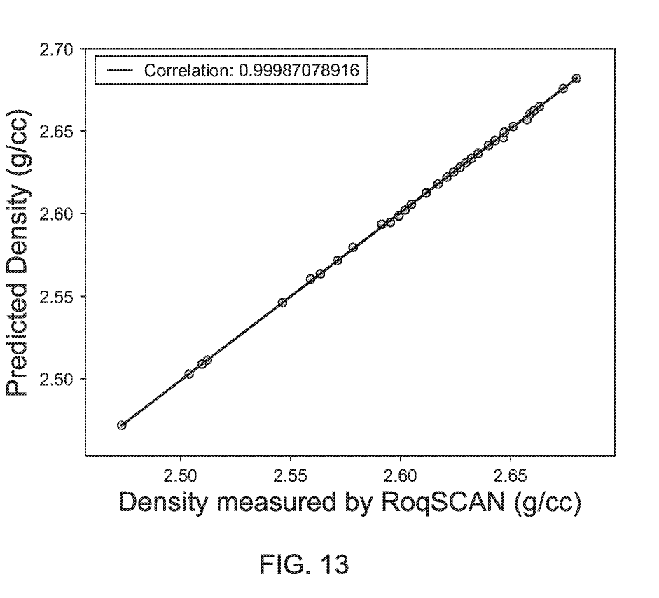

FIGS. 11-13 illustrate the prediction accuracy of p-wave velocity, s-wave velocity and density, respectively. Specifically FIG. 11 is a graph illustrating auxiliary well p-wave velocity prediction versus p-wave velocity obtained by RoqSCAN based on analyzing rock samples. FIG. 12 is also a graph that illustrates auxiliary well s-wave velocity prediction versus s-wave velocity obtained by RoqSCAN based on analyzing rock samples, and FIG. 13 is yet another graph that illustrates auxiliary well density prediction versus density obtained by RoqSCAN based on analyzing rock samples. The exceptional correlation between predicted and “measured” values proved that the calibrated prediction model yields reliable results for the auxiliary well. As the target horizontal wells do not have sonic and density logs, the predicted elastic properties are very useful for constraining elastic earth modeling processes for reservoir characterization and completion optimization studies.

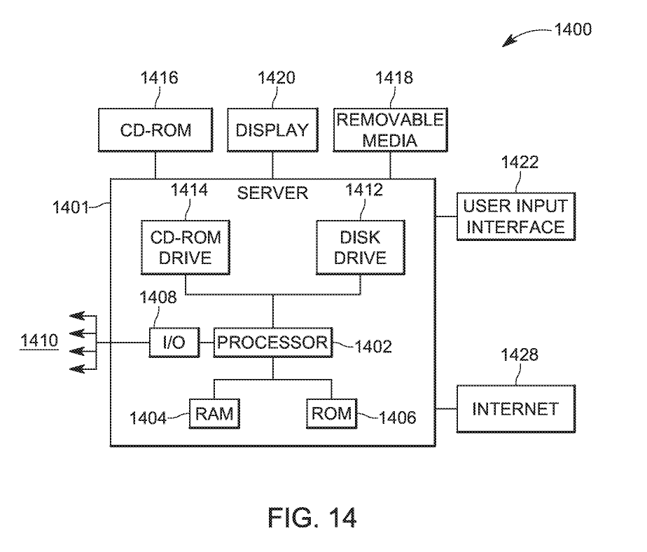

The above-discussed methods may be implemented in a geophysical investigation device as illustrated in FIG. 14. Hardware, firmware, software or a combination thereof may be used to perform the various steps and operations described herein. Exemplary device 1400 suitable for performing the activities described in the above embodiments may include a server 1401. Such a server 1401 may include a central processor (CPU) 1402 coupled to a random-access memory (RAM) 1404 and to a read-only memory (ROM) 1406. Here, the term “central processor” encompasses all available processors including graphic and parallel processors. ROM 1406 may also be other types of storage media to store programs, such as programmable ROM (PROM), erasable PROM (EPROM), etc. Processor 1402 may communicate with other internal and external components through input/output (I/O) circuitry 1408 and bussing 1410 to provide control signals and the like.

Processor 1402 carries out a variety of functions as are known in the art, as dictated by software and/or firmware instructions. Server 1401 may also include one or more data storage devices, including hard drives 1412, CD-ROM drives 1414 and other hardware capable of reading and/or storing information, such as DVD, etc. In one embodiment, software for carrying out the above-discussed steps may be stored and distributed on a CD-ROM or DVD 1416, a removable media 1418 or other form of media capable of portably storing information. These storage media may be inserted into, and read by, devices such as CD-ROM drive 1414, disk drive 1412, etc. Server 1401 may be coupled to a display 1420, which may be any type of known display or presentation screen, such as LCD, plasma display, cathode ray tube (CRT), etc. A user input interface 1422 is provided, including one or more user interface mechanisms such as a mouse, keyboard, microphone, touchpad, touch screen, voice-recognition system, etc.

Server 1401 may be coupled to other systems, such as the RoqSCAN™. The server may be part of a larger network configuration as in a global area network (GAN) such as the Internet 1428, which allows ultimate connection to various landline and/or mobile computing devices.

Some advantages of the above-described embodiments are: increasing the accuracy of rock physics models integrating rock sample measurement with “logs,” predicting rock fabric and texture “logs” that cannot be measured using well logging tools and applying calibrated prediction models on wells without rock samples. Better understanding of unconventional (i.e., exploited by fracking) hydrocarbon reservoir characteristics based on a detailed knowledge of mineral, textural, petrophysical and elastic properties leads to maximizing hydrocarbon returns and reducing costs, for example, by more effective placement of fracking stations.

The disclosed exemplary embodiments provide for predicting mineralogical, textural, petrophysical and/or elastic properties in wells at locations without rock samples. This description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for predicting values of one or more mineralogical, textural, petrophysical and/or elastic property at locations without rock samples, the method comprising:
obtaining well log data and values of a target property measured by analyzing rock samples acquired at rock sample locations;
building and calibrating a prediction model using machine learning algorithms, the well log data and the values of the target property at the rock sample locations; and
estimating values of the target property at one or more locations without rock samples using the prediction model.

2. The method of claim 1, wherein the building and calibrating includes upscaling values in the well log data so as to correspond to the rock sample locations.

3. The method of claim 1, wherein the well log data includes values of gamma ray, resistivity, density, neutron porosity, and/or compressional sonic data.

4. The method of claim 1, wherein features included in the well log data are measured 10-100 times between adjacent among the rock sample locations.

5. The method of claim 1, wherein the machine learning algorithms include any one of a gradient boost regression, a random forest regression, single and multiple linear and non-linear regressions, neural networks, support vector machines and Bayesian methods.

6. The method of claim 1, wherein analyzing the rock samples includes one or more of automated mineralogy, quantitative pore analysis, grain size and shape analysis, rock typing, quantitative lithotyping, rheology, high resolution backscattering electron and secondary electron imaging, scanning electron microscopy and energy dispersive spectroscopy.

7. The method of claim 1, wherein the one or more locations are in another well than a well in which the well log data was acquired, and the prediction model is applied using other well log data acquired in the another well.

8. A geophysical investigation device configured to predict values of at least one mineralogical, textural, petrophysical, and/or elastic property at locations without rock samples, the device comprising:
an interface configured to obtain well log data and values of a target property acquired from analyzing rock samples at rock sample locations; and
a processor configured
to build and calibrate a prediction model using machine learning algorithms, the well log data and the values of the target property at the rock sample locations, and
to estimate values of the target property at one or more locations without rock samples using the prediction model.

9. The device of claim 8, wherein the processor upscales values in the well log data corresponding to the rock sample locations for building and calibrating the prediction model.

10. The device of claim 8, wherein the well log data includes values of gamma ray, resistivity, density, neutron porosity, and/or compressional sonic data.

11. The device of claim 8, wherein features included in the well log data are measured 10-100 times between adjacent among the rock sample locations.

12. The device of claim 8, wherein the machine learning algorithms include any one of a gradient boost regression, a random forest regression, single and multiple linear and non-linear regressions, neural networks, support vector machines and Bayesian methods.

13. The device of claim 8, wherein analyzing the rock samples includes one or more of automated mineralogy, quantitative pore analysis, grain size and shape analysis, rock typing, quantitative lithotyping, rheology, high resolution backscattering electron and secondary electron imaging, scanning electron microscopy and energy dispersive spectroscopy.

14. The device of claim 8, wherein the one or more locations are in another well than a well in which the well log data was acquired, and the prediction model is applied using other well log data acquired in the another well.

15. A non-transitory computer readable medium storing executable instructions which, when executed by a processor, implement a method for predicting values of at least one mineralogical, textural, petrophysical and/or elastic property at locations without rock samples, the method comprising:
obtaining well log data and values of a target property acquired from analyzing rock samples at rock sample locations;
building and calibrating a prediction model using machine learning algorithms, the well log data and the values of the target property at the rock sample locations; and
estimating values of the target property at one or more locations without rock samples using the prediction model.

16. The non-transitory computer readable medium of claim 15, when the prediction model is built and calibrated values in the well log data are upscaled to correspond to the rock sample locations.

17. The non-transitory computer readable medium of claim 15, wherein the well log data includes values of gamma ray, resistivity, density, neutron porosity, and/or compressional sonic data, and
analyzing the rock samples includes one or more of automated mineralogy, quantitative pore analysis, grain size and shape analysis, rock typing, quantitative lithotyping, rheology, high resolution backscattering electron and secondary electron imaging, scanning electron microscopy and energy dispersive spectroscopy.

18. The non-transitory computer readable medium of claim 15, wherein features included in the well log data are measured at least 10-100 times between adjacent among the rock sample locations.

19. The non-transitory computer readable medium of claim 15, the machine learning algorithms include any one of a gradient boost regression, a random forest regression, single and multiple linear and non-linear regressions, neural networks, support vector machines and Bayesian methods.

20. The non-transitory computer readable medium of claim 18, wherein the one or more locations are in another well than a well in which the well log data was acquired, and the prediction model is applied using other well log data acquired in the another well.
